(19) United States
(12) Patent Application Publication
(10) Pub. No.: US 2008/0241673 A1
(43) Pub. Date: Oct. 2, 2008

(54) PRISMATIC CELL

(75) Inventors: Satoshi Yoshida, Moriguchi-shi (JP); Eiji Okutani, Moriguchi-shi (JP); Yoshikumi Miyamoto, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 12/058,957

(22) Filed: Mar. 31, 2008

(30) Foreign Application Priority Data
Mar. 30, 2007 (JP) 2007-090911

(51) Int. Cl. H01M 2/02

(52) U.S. Cl. 429/163; 29/623.1

(57) ABSTRACT

A prismatic cell capable reliably inhibiting swelling of the cell is provided. The prismatic cell includes an electrode assembly having a positive electrode and a negative electrode, an electrolytic solution, and a prismatic outer casing housing the electrode assembly and the electrolytic solution. The outer casing has an inwardly depressed portion in the central portion of a side surface of the outer casing having a largest area among the four side surfaces of the prismatic outer casing. The depressed portion has at least one swelling prevention groove.

### BACKGROUND OF THE INVENTION

1) Field of the Invention

The present invention relates to a technique for inhibiting swelling of prismatic cells.

2) Description of the Related Art

Non-aqueous electrolyte secondary cells, for their high energy density and high capacity, are widely used as power sources for mobile appliances. In particular, non-aqueous electrolyte secondary cells in prismatic cell applications are highly usable for their easy mountability in spatially demanding mobile appliances.

Non-aqueous electrolyte secondary cells swell because of swelling of the positive electrode and the negative electrode caused by charge/discharge reactions. Further, the positive electrode and/or the negative electrode react with the non-aqueous electrolyte to generate gas that causes the swelling of the cells. If a cell mounted in an electronic appliance swells, electronic circuits and the like disposed around the cell may be damaged. Thus, there is a need for minimizing cell swelling.

In order to meet this demand, Japanese Patent Application Publication Nos. 2001-313063 (patent document 1), 2002-42741 (patent document 2), 2005-196991 (patent document 3), and 2006-40879 (patent document 4) propose forming in advance a depressed portion on a side surface of the outer casing of the prismatic cell having the largest area.

However, these techniques still cannot inhibit cell swelling sufficiently.

### SUMMARY OF THE INVENTION

The present invention has been accomplished in order to solve the above problem, and it is an object of the present invention to provide a prismatic cell capable of reliably inhibiting cell swelling.

In order to accomplish the above-mentioned object, a prismatic cell according to the present invention includes: an electrode assembly having a positive electrode and a negative electrode; an electrolytic solution; and a prismatic outer casing housing the electrode assembly and the electrolytic solution. The outer casing has an inwardly depressed portion in a central portion of a side surface of the outer casing, the side surface having a largest area among four side surfaces of the prismatic outer casing. The depressed portion has at least one swelling prevention groove.

With this configuration, the depressed portion formed in advance on the side surface of the outer casing having the largest area serves to absorb the swelling deformation of the cell. Further, the swelling prevention groove formed on the depressed portion serves to inhibit swelling of the central portion of the cell. These effects collaborate to inhibit the swelling of the cell reliably.

While among the four side surfaces of the outer casing the largest area usually corresponds to a pair of opposing side surfaces (i.e., two side surfaces), the largest area may correspond to one side surface in some cases. As used herein, the central portion of the side surface of the outer casing having the largest area means a portion of the side surface defined by a portion of 5 mm from the bottom of the largest area side surface, a portion of 5 mm from the edge on the sealing plate side, and portions of 5 mm from both side edge. In order to inhibit the swelling of the cell effectively, as shown in FIG. 2(a), a depressed portion 2 is preferably formed about a central area point of the side surface having the largest area and constitutes at least 36% of the side surface (i.e., the 36% portion being defined by a central 60% portion of the width of the cell and a central 60% portion of the height of the cell).

In order to inhibit the swelling of the cell effectively, as shown in FIG. 2(b), the maximum depth of the depressed portion is preferably 0.05 mm or more. If the maximum depth of the depressed portion is more than 0.1 mm, the electrode assembly and the electrolytic solution are difficult to house in the outer casing. In view of this, the maximum depth of the depressed portion is preferably 0.1 mm or less.

In the case of a single swelling prevention groove, it preferably passes through the central area point of the side surface of the outer casing having the largest area and is parallel with the height of the cell.

In the case of a plurality of swelling prevention grooves, they are preferably formed about a symmetry axis that passes through the central area point of the side surface of the outer casing having the largest area and that is parallel with the height of the cell. In this case, if the distance between neighboring swelling prevention grooves is less than 3 mm, the portion between the neighboring grooves swells because of stress associated with formation of the swelling prevention grooves, which is not preferable. If the distance between neighboring swelling prevention grooves is more than 6 mm, the portion between the neighboring grooves may swell because of the swelling of the positive and negative electrodes and generation of gas, which is not preferable. In view of this, the distance between the neighboring swelling prevention grooves is preferably 3 to 6 mm.

In order to accomplish the above-mentioned object, a method for producing a prismatic cell according to the present invention includes the steps of: forming a depressed portion on a side surface of a prismatic outer casing, the side surface having a largest area among four side surfaces of the prismatic outer casing; housing an electrode assembly having a positive electrode and a negative electrode into the prismatic outer casing having the depressed portion; sealing an opening of the prismatic outer casing with a sealing material; injecting an electrolytic solution into the cell and then plugging the cell; and forming at least one swelling prevention groove on the depressed portion of the largest area side surface of the sealed outer casing.

The depressed portion on the outer casing is preferably formed before housing of the electrode assembly and the electrolytic solution. The swelling prevention groove on the depressed portion is preferably formed after sealing of the opening of the outer casing, injection of the electrolytic solution, and plugging of the cell.

### BRIEF DESCRIPTION OF THE DRAWINGS

FIG. 1 is a perspective view of a cell according to the present invention.

FIG. 2 shows the cell according to the present invention: FIG. 2 (a) is a front view of the cell; and FIG. 2(b) is a side perspective view of the cell.

FIG. 3 shows the cell surface after charging: FIG. 3(a) shows the case of comparative example 1; and FIG. 3(b) shows the case of example 1.

FIG. 4 is a side perspective view of a depressed portion according to a modified example of the present invention.

FIG. 5 is a perspective view of a cell according to comparative example 1.

### DESCRIPTION OF THE PREFERRED EMBODIMENTS

The preferred embodiments of the present invention will be described by referring to a non-aqueous electrolyte secondary cell as an example in conjunction with the drawings. It will be understood that the present invention will not be limited by the embodiments below; modifications are possible without departing from the scope of the present invention.

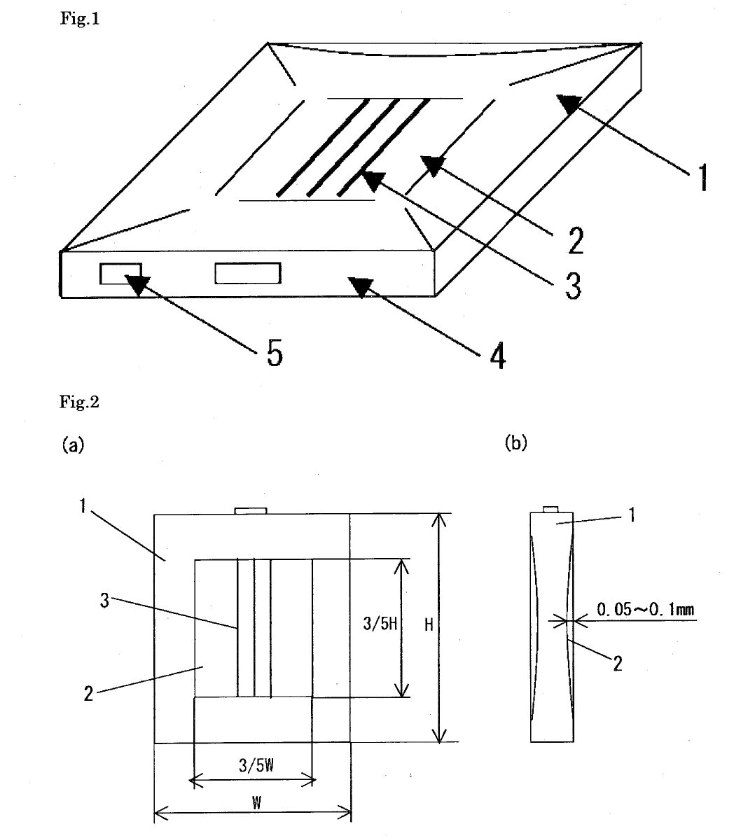

FIG. 1 is a perspective view a cell according to the present invention, FIG. 2 (a) is a front view of the cell, and FIG. 2(b) is a side perspective view of the cell. An outer casing 1 of the cell has a depressed portion 2 in the central portion of a side surface of the outer casing 1 having the largest area. The depressed portion 2 has three swelling prevention grooves 3.

The cell is 50 mm high, 34 mm wide, and 5.2 mm thick. Assume that the height of the largest area side surface of the outer casing 1 is H and the width of this side surface is W. As shown in FIG. 2, the depressed portion 2 is disposed about the central area point of the side surface of the outer casing 1 having the largest area and is at least defined by ⅗ H and ⅗ W. The deepest portion of the depressed portion 2 is 0.05 to 0.1 mm in depth. The distance between the swelling prevention grooves 3 is 3 to 6 mm.

The non-aqueous electrolyte secondary cell can be produced with known materials by known methods. Specifically, examples of the positive electrode material include lithium-containing transition metal composite oxide such as lithium cobalt acid, lithium nickel acid, and lithium manganese acid. Examples of the negative electrode material include carbonaceous material such as graphite and coke, a lithium alloy, and metal oxide. Examples of the non-aqueous solvent include carbonate such as ethylene carbonate and diethyl carbonate, ester such as γ-butyrolactone, and ether such as 1,2-dimethoxyethane. Examples of the electrolytic salt include LiN(CF₃SO₂)₂ and LiPF₆. These may be used alone or in a mixture of two or more of them. It should be noted that the present invention also finds applications in nickel-hydrogen storage cells or batteries and nickel-cadmium cells or batteries.

The present invention will be described in further detail by referring to examples.

### Example 1

### Depressed Portion Forming Step

An aluminum prismatic outer casing 1 of 50 mm high, 34 mm wide, and 5.2 thick was prepared by drawing processing. Simultaneously with the drawing processing, as shown in FIG. 2, a depressed portion 2 having a maximum depth of 0.05 mm was formed about the central area point of the side surface of the outer casing 1 having the largest area so that the depressed portion 2 would constitute 36% of the side surface (i.e., a portion of 30 mm high and 20.4 wide about the central area point of the side surface of the outer casing 1 having the largest area).

<Housing Step>

An electrode assembly having a positive electrode mainly made of lithium cobaltate, a negative electrode mainly made of graphite, and a separator made of a polyolefin porous film was housed in the outer casing 1, and the opening of the outer casing 1 was sealed with a sealing material 4. Then, an electrolytic solution having electrolyte salt made of LiPF₆ and dissolved in a non-aqueous solvent made of a mixture of ethylene carbonate and diethyl carbonate was injected through an injection port provided on the sealing plate 4.

<Plugging Step>

A plug 5 was inserted in the injection port, and the periphery of the plug 5 was welded.

<Swelling Prevention Groove Forming Step>

In the central portion of the depressed portion 2, three lines of swelling prevention groove 3 with 0.3 mm width were formed in parallel with the height of the cell and at 4 mm intervals. This forming step is carried out using a roller having a diameter of 17 mm. And, the periphery of the roller convexes in an arc with a radius of 2.5 mm. Thus, a non-aqueous electrolyte secondary cell according to example 1 was prepared.

### Comparative Example 1

A non-aqueous electrolyte secondary cell according to comparative example 1 was prepared in the same manner as example 1 except that no depressed portion was formed on the outer casing (see FIG. 5).

[Measurement of Cell Thickness]

The thickness of each of the prepared cells was measured before and after groove processing.

The groove-formed cells were charged at a constant current of 1 It (1050 mA) for 18 minutes to measure the thickness of each cell (30% charging thickness).

The groove-formed cells were charged at a constant current of 1 It (1050 mA) to a voltage of 4.2 V, and then charged at a constant voltage of 4.2 V to a current of 51 mA to measure the thickness of each cell (full charging thickness).

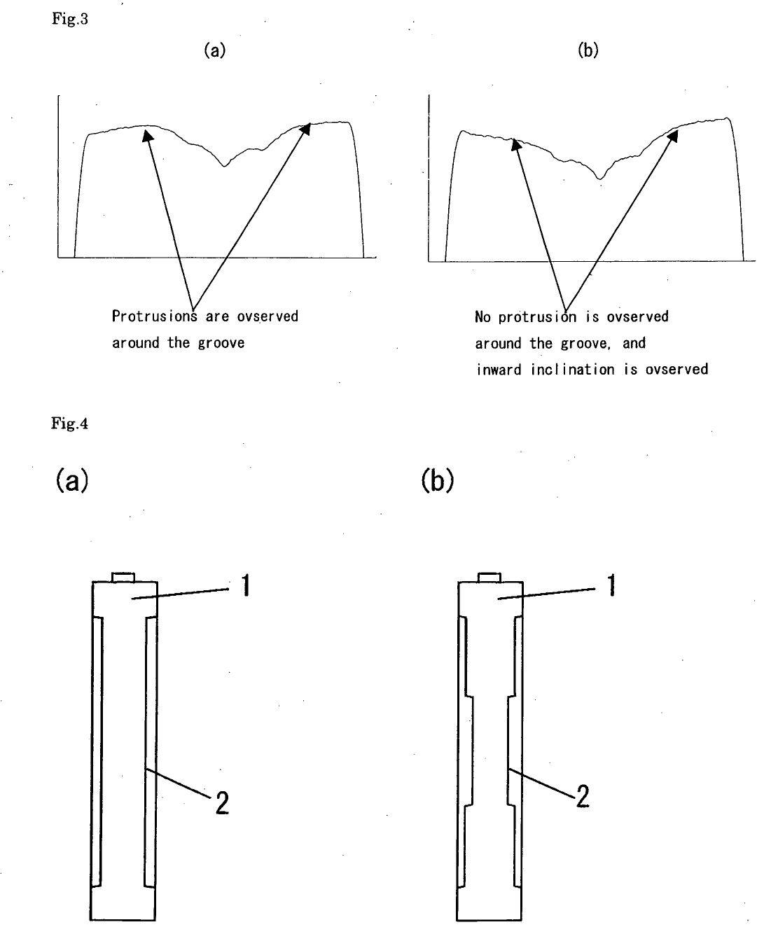

The results are shown in Table 1 below (on 20 cells for example 1 and comparative example 1 each). In Table 1, the value outside the parenthesis denotes an average value, and the values inside the parenthesis denote variation. The shape of the vicinity of the swelling prevention groove of example 1 after full charging is shown in FIG. 3(b), while the shape of the vicinity of the swelling prevention groove of comparative example 1 after full charging is shown in FIG. 3(a).

TABLE 1

| | Comparative | |
|---|---|---|
| | Example 1 | Example 1 |
| Thickness before groove | 5.18 (5.17-5.18) | 5.18 (5.17-5.18) |
| processing (mm) | | |
| Thickness after groove processing | 5.25 (5.23-5.28) | 5.22 (5.19-5.24) |
| (mm) | | |
| 30% charging thickness (mm) | 5.31 (5.26-5.35) | 5.27 (5.25-5.29) |
| Full charging thickness (mm) | 5.42 (5.37-5.44) | 5.35 (5.30-5.39) |

Table 1 shows that the thickness of the cells according to example 1 after groove processing is 5.22 mm in average, which is 0.03 mm thinner than 5.25 mm for comparative example 1.

A possible explanation is as follows. If the outer casing is subjected to groove processing, the associated stress deforms the outer casing resulting in swelling. If a depressed portion is provided in advance on the side surface of the outer casing having the largest area, the depressed portion serves to inhibit the swelling. Thus, the cell thickness of example 1 after groove processing is smaller than that of comparative example 1.

Table 1 also shows that the 30% charging thickness of the cells according to example 1 is 5.27 mm in average, which is 0.04 mm thinner than 5.31 mm for comparative example 1.

Table 1 also shows that the full charging thickness of the cells according to example 1 is 5.35 mm in average, which is 0.07 mm thinner than 5.42 mm for comparative example 1.

A possible explanation is as follows. Charging a cell causes the reaction of intercalating lithium ions by the negative electrode. Since this causes an increase in the volume of the negative electrode, the volume of the electrode assembly is increased accordingly, resulting in the swelling of the cell. If a depressed portion is provided in advance on the side surface of the outer casing having the largest area, and a swelling prevention groove is formed on the depressed portion, then the effect by the depressed portion to absorb the swelling of the cell and the effect by the swelling prevention groove to inhibit the swelling of the cell collaborate to inhibit the swelling of the cell effectively. If no depressed portion is formed, the effect to inhibit cell swelling is insufficient, resulting in increased cell thickness.

The results can be confirmed by FIG. 3, which shows the cell surface after charging. As shown in FIG. 3(a) for comparative example 1, in which no depressed portion is formed, the surrounding portions of the swelling prevention groove protrude significantly (i.e., portions protruding upward in the figure exist as indicated by the arrows), whereas as shown in FIG. 3(b) for example 1, in which the depressed portion is formed, no protrusion is observed on the surrounding portions of the swelling prevention groove (i.e., no portions protruding upward in the figure exist as indicated by the arrows). Thus, increase in cell thickness of example 1 is minimized.

[Charging High Temperature Preservation Test]

The prepared cells were charged at a constant current of 1 It (1050 mA) to a voltage of 4.2 V, and then charged at a constant voltage of 4.2 V to a current of 51 mA to measure the thickness of each cell (thickness before testing).

Then, the cells were preserved in a thermostatic chamber of 85° C. for 3 hours to measure the thickness of each cell (thickness right after withdrawal).

Then, the cells were cooled to room temperature (25° C.) to measure the thickness of each cell (thickness after cooling).

The results are shown in Table 2 below (on 5 cells for example 1 and comparative example 1 each). In Table 2, the value outside the parenthesis denotes an average value, and the values inside the parenthesis denote variation.

TABLE 2

| | Comparative | |
|---|---|---|
| | Example 1 | Example 1 |
| Thickness before testing (mm) | 5.42 (5.42-5.43) | 5.34 (5.29-5.38) |
| Thickness right after withdrawal | 6.31 (6.27-6.38) | 6.12 (6.02-6.17) |
| (mm) | | |
| Thickness after cooling (mm) | 5.82 (5.78-5.90) | 5.69 (5.62-5.73) |

Table 2 shows that the thickness of the cells according to example 1 before testing is 5.34 mm in average, which is 0.08 mm thinner than 5.42 mm for comparative example 1.

This is for the same reason as the one discussed in regard to the full charging thickness.

Table 2 also shows that the thickness of the cells according to example 1 right after withdrawal is 6.12 mm in average, which is 0.19 mm thinner than 6.31 mm for comparative example 1.

Table 2 also shows that the thickness of the cells according to example 1 after cooling is 5.69 mm in average, which is 0.13 mm thinner than 5.82 mm for comparative example 1.

A possible explanation is as follows. If a fully charged cell is preserved in a high-temperature environment, the non-aqueous electrolyte and the electrodes react with each other to generate gas, resulting in the swelling of the cell. If a depressed portion is provided in advance on the side surface of the outer casing having the largest area, and a swelling prevention groove is formed on the depressed portion, then the effect by the depressed portion to absorb the swelling of the cell and the effect by the swelling prevention groove to inhibit the swelling of the cell collaborate to inhibit the swelling of the cell effectively. If no depressed portion is formed, the effect to inhibit cell swelling is insufficient, resulting in increased cell thickness.

### SUPPLEMENTARY REMARKS

While aluminum is used in example 1 for the outer casing material by way of example, known material such as an aluminum alloy, iron, and stainless steel may be used.

While the present invention is related to a cell with a prismatic outer casing, the prismatic outer casing encompasses outer casings whose corners are curved.

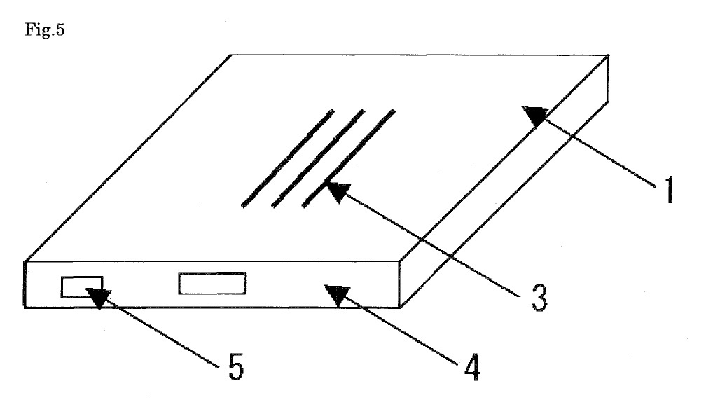

The depressed portion may be formed in a curved shape as shown in FIG. 2 or a steep step shape as shown in FIG. 4(a), or may have a plurality of steps as shown in FIG. 4(b).

The cross sectional shape of the swelling prevention groove in the width direction is not particularly limited. The maximum width of the groove in a cross section in the width direction is preferably 0.2 to 0.5 mm.

What is claimed is:

1. A prismatic cell comprising:
an electrode assembly having a positive electrode and a negative electrode;
an electrolytic solution; and
a prismatic outer casing housing the electrode assembly and the electrolytic solution, wherein:
the outer casing has an inwardly depressed portion in a central portion of a side surface of the outer casing, the side surface having a largest area among four side surfaces of the prismatic outer casing; and
the depressed portion has at least one swelling prevention groove.

2. The prismatic cell according to claim 1, wherein the depressed portion is formed about a central area point of the side surface having the largest area and constitutes at least 36% of the side surface.

3. The prismatic cell according to claim 1, wherein the maximum depth of the depressed portion is 0.05 to 0.1 mm.

4. The prismatic cell according to claim 1, comprising a plurality of swelling prevention grooves with a distance of 3 to 6 mm between neighboring grooves.

5. The prismatic cell according to claim 1, comprising a non-aqueous electrolyte secondary cell.

6. The prismatic cell according to claim 1, wherein the prismatic outer casing is made of aluminum or an aluminum alloy.

7. The prismatic cell according to claim 1, comprising a single swelling prevention groove provided in parallel with the height of the prismatic outer casing.

8. The prismatic cell according to claim 1, comprising a plurality of swelling prevention grooves about a symmetry axis, the symmetry axis being a straight line parallel with the height of the prismatic outer casing.

9. A method for producing a prismatic cell, comprising the steps of
forming a depressed portion on a side surface of a prismatic outer casing, the side surface having a largest area among four side surfaces of the prismatic outer casing;
housing an electrode assembly having a positive electrode and a negative electrode into the prismatic outer casing having the depressed portion;
sealing an opening of the prismatic outer casing with a sealing material;
injecting an electrolytic solution into the cell and then plugging the cell; and
forming at least one swelling prevention groove on the depressed portion of the largest area side surface of the sealed outer casing.

10. The method according to claim 9, wherein the prismatic cell is a non-aqueous electrolyte secondary cell.

11. The method according to claim 9, wherein the prismatic outer casing is made of aluminum or an aluminum alloy.
